(19) United States
(12) Patent Application Publication
(10) Pub. No.: US 2019/0311515 A1
(43) Pub. Date: Oct. 10, 2019

(54) COMPUTER SYSTEM FOR CONFIGURING 3D MODELS USING OFFSET TRANSFORMS

(71) Applicant: Luxion Inc., Tustin, CA (US)

(72) Inventors: Claus Wann Jensen, Silkeborg (DK); Henrik Wann Jensen, Solana Beach, CA (US)

(73) Assignee: Luxion Inc., Tustin, CA (US)

(21) Appl. No.: 16/373,545

(22) Filed: Apr. 2, 2019

Related U.S. Application Data
(60) Provisional application No. 62/653,443, filed on Apr. 5, 2018.

(51) Int. Cl. G06T 13/20; G06T 19/20; G06F 17/50

(52) U.S. Cl. CPC G06T 13/20; G06T 19/20; G06T 2219/2021; G06T 2219/2016; G06T 2219/2012; G06F 17/50

(57) ABSTRACT

The present invention includes a novel way of specifying the possible configurations of a product and representing this compactly using offset transforms. The offset transforms make it possible to save just the basic 3D geometry and representing all the configuration options using offset transforms. This results in a significantly more compact representation as compared with a full representation of the various configurations. This means that a product with thousands of configuration options including animations can be represented using a compact file format where only the base 3D data is represented along with offset transforms to represent the various configuration options. This further makes it possible to easily transmit full configurations of a product and enables a viewer to view the configuration options by applying offset transforms to the original 3D model.

### CROSS REFERENCE TO RELATED APPLICATIONS

This application claims priority under 35 U.S.C. § 119(e) to U.S. Provisional Application No. 62/653,443, filed Apr. 5, 2018, and entitled “Computer system for configuring 3D models using offset transforms,” the disclosure of which is hereby incorporated by reference in its entirety.

### 1. FIELD OF INVENTION

The present invention relates generally to a method and apparatus for animating and configuring three-dimensional (3D) models with a 3D animation system using offset transforms, and more specifically, to a system for enabling different configurations, transmission of the different configurations, viewing of the different configurations and using offset transforms to represent the different configurations.

### 2. DESCRIPTION OF RELATED ART

Computer generated imagery includes the generation of static and dynamic moving images, where computer animation refers just to the dynamic moving images. Computer animation is a process used to generate animated moving images by using computer graphics. Modern computer animation usually uses 3D computer graphics, although 2D computer graphics are still used for stylistic, low bandwidth, and faster real-time renderings. Sometimes the end target for the computer animation is the computer itself, but other times the end target is another medium, such as a scene in a film.

To create the illusion of movement in 3D computer animation, along with television and films, an image is displayed on the computer screen and repeatedly replaced by a new image that is similar to the previous image, but advanced slightly in the time domain (e.g., at a rate of 24 or 30 frames/second). An example for how to move an object (e.g., a car) in 3D animation includes initially setting the screen's background to a color, such as black. Then, the car is drawn on the left of the screen. Next, the background is unchanged, but the car is duplicated slightly to the right of its original position. This process is repeated, each time moving the car a bit to the right. If this process is repeated fast enough, the car will appear to move smoothly to the right. This basic procedure is used for all moving pictures in films and television as well. Besides shifting an object, 3D animation can perform more complex transformations on the object, such as a change in size, shape, lighting effects, etc.

Conventional 3D computer animation uses keyframing. Keyframing is where specific attributes of a system are specified to occur at the position of specific frames. In keyframing (e.g., programmed keyframed movement, keyframes, etc.), the user sets the position for an object at a given frame and then sets a new position for the object at another frame, and for all the intermediate frames, the system will move the object smoothly between the two positions. The images are called frames because their position in time is measured in frames on a strip of film.

A conventional human animator or user can use keyframing to create animation data. Modeled objects can be constructed out of geometrical vertices, faces, and edges in a 3D coordinate system. The user can also use motion capture, either together with or separate from keyframing, to create animation data.

Designing animation using keyframes is one of the traditional challenges of 3D animation. Even for simple animations using keyframes, the setup and design is often very tedious and challenging, such that expert knowledge is required. Furthermore, keyframe-based animations are difficult to edit as well. Editing a keyframe-based animation requires that all of the control points of the animation curves associated with the system be modified.

### SUMMARY OF THE INVENTION

The present invention includes a novel way of specifying the possible configurations of a product, to represent and transmit the possible configurations compactly using offset transforms. The offset transforms make it possible to save just the basic 3D geometry, as all the configuration options are represented using offset transforms. The basic 3D geometry is the base 3D data representing a 3D model. This results in a significantly more compact representation as compared with a full representation of the various configurations. This means that a product with thousands of configuration options including animations can be represented using a compact file format where only the base 3D data is represented along with offset transforms to represent the various configuration options. This further makes it possible to easily transmit full configurations of a product and enables a viewer to view the configuration options by applying offset transforms to the original 3D model.

To simplify the process of creating configurations of 3D models, a novel system has been developed based on offset transforms. The use of offset transforms makes it possible to make configuration components that can be added individually to the configuration of a 3D model. Rather than specifying the exact configuration of a 3D object, the user can create configurations by changing elements of the model using offset transforms. The offset transforms are independent but can be combined to form any number of configurations.

An example of the use of offset transforms is an animation system, where a geometric component can be rotated, translated, and scaled. With offset transforms these transformations can be applied in sequence to describe a more complex animation of a given component.

An offset is an animation component change, where each animation component change acts as an offset of the previous animation component, which makes it possible to add multiple rotations to a given object. For example, the user can add a rotation to a given object, and then later add another rotation to the object. The effect will be adding the two rotations. If the rotations are the same the effect will be doubling the speed of the rotation of the object.

Mathematically, each animation component for movements can be described using a matrix that describes how to move a specific 3D element in the scene. If multiple animations are added to the same 3D element, then the combined action of the matrices is computed by multiplying the individual matrices to obtain a combined animation, where each matrix builds upon the previous animation (and uses the previous animation component as the offset). Animations are added individually to objects. Animations can be added, deleted, and modified while the system is in use. Animation components can also be copied and pasted, or moved onto other objects.

The animation of a model can be organized hierarchically if the 3D model has multiple elements. In this situation, an animation component can be applied to a group of 3D parts within the model. Each part may in addition have its own unique set of animation components. The animations are combined hierarchically in order to move all the parts of the 3D model precisely. An example could be a 3D car model, where the wheel parts rotate inside the model, while the entire car body is being translated (moved). The wheel will rotate and then move with the entire car model.

There is a timeline in the animation system, where each animation component can be accessed. Each animation component has a starting time and a duration. The animation can be added to an object and the starting time and the duration can be changed freely. The starting time and duration can also be changed interactively in the timeline. For example, an object can be moved first and rotated later.

The model is visualized using a photorealistic realtime ray tracing system. The system supports interactive playback of animations. While the animations are playing it is possible to move the camera, change materials, and add new animations. The individual animation components can also be modified during playback to directly see the effect of the parameter changes. Animations can also be deleted during playback.

It is also possible to freeze the animation at a given time and view the object in a specific pose. The rendering system is progressive and the quality improves the longer a given frame is being viewed.

The user can also combine animations into complex animation behaviors and save this combination into a library of new animation components. An example could be combining a translation and a rotation into one component. This new component can be applied to an object to make it both translate and rotate.

It is also possible to represent states of the geometry such as hidden and visible states using a vector. This vector can be updated using a matrix and as such work exactly like the animation components above.

Materials applied to the 3D model likewise take as input a vector of parameters controlling specific aspects of the material appearance. This vector can be updated using offset transforms that represent the changes to the material.

The lighting environment can be rotated using a 4 dimensional transformation matrix. It is also possible to use the vectorized hidden and show states to change lighting dynamically.

A camera can be placed to view the model from a specific viewing angle. The camera position, viewing direction, and field of view can be represented by a 4 dimensional matrix and any changes to the camera view is represented as an offset transformation matrix.

An advantage of the invention is that a configurator with offset transforms quickly creates many thousands of combinations of images. Computer generated images of 3D models are often used for design and marketing of products. Each product can appear in different colors, in different sizes, with different functionality, and with different parts. This is part of the product configuration. When looking at all the variations of a given product, there can be hundreds or more combinations. Creating images of all of these combinations with conventional methods is a time consuming task, but using offset transforms representative of various configuration options can be created quickly.

Another advantage of the invention is that the offset transforms, which represent configuration options, provide a cost savings. The offset transforms make it possible to save just the basic 3D geometry, along with the offset transforms of all the possible configuration options, as opposed to saving the thousands images of the product with each configuration option. By contrast, if the designer or marketing person wants to show animations of the product, this would conventionally be shown as videos, and with the number of combinations this could be thousands of videos, which would be very costly to produce. Similarly, if a designer or marketing person using conventional methods wishes to show images of the product from different camera angles and in different lighting conditions, the number of required images can grow into several thousand.

A further advantage of the present invention is that multiple animation components allow for creating and editing 3D animation without the need for complicated keyframing. As a result, the user can move an object without having to specify the precise position where the object should move to. Also, the user can add various animation components simultaneously or in sequence to move and/or change the look/appearance of the object. As such, 3D animation creating and editing is based on time, not frame positioning as in keyframing. Multiple animation components are used to simplify the conventional process of animating 3D models. This simpler method is easier to perform, and can be performed by people who are not computer animation experts.

The foregoing, and other features and advantages of the invention, will be apparent from the following, more particular description of the preferred embodiments of the invention, the accompanying drawings, and the claims.

### BRIEF DESCRIPTION OF THE DRAWINGS

FIG. 1 illustrates a 3D animation system having animation components for moving objects according to one embodiment of the invention.

FIG. 2 illustrates the animation components within the system according to one embodiment of the invention.

FIG. 3 illustrates an animation timeline according to one embodiment of the invention.

FIG. 4 illustrates a flow chart showing a process of applying animation components to a 3D scene according to one embodiment of the invention.

FIG. 5 illustrates a flow chart showing a process of configuring components to a 3D scene according to one embodiment of the invention.

FIG. 6 illustrates an authoring application within the system according to one embodiment of the invention.

FIGS. 7-10 illustrate close up views of the authoring application according to embodiments of the invention.

FIG. 11 illustrates a viewing application within the system according to one embodiment of the invention.

FIGS. 12-13 illustrate close up views of the viewing application according to embodiments of the invention.

FIG. 14 illustrates a flow chart showing a process of configuring components to a 3D scene according to one embodiment of the invention.

### DETAILED DESCRIPTION OF THE INVENTION

Before the present composition, methods, and methodologies are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Unless defined otherwise, all technical and scientific terms used herein have the same meaning as commonly understood by one of ordinary skill in the art to which this invention belongs. Any methods and materials similar or equivalent to those described herein can be used in the practice or testing of the invention, as it will be understood that modifications and variations are encompassed within the spirit and scope of the instant disclosure.

The present invention relates to a novel 3D animation system for animating models. The system uses offset transforms which make it possible to make animation components that can be added individually to the animation system. The animation components simplify the process of animating 3D models performed conventionally. For example, the user can apply various animation components to the 3D object to make it move for a specific time, rather than the conventional process of specifying the precise position of a 3D object at specific frames. Although the invention is sometimes illustrated and described in the context of 3D animations, one of ordinary skill in the art can apply these concepts in other dimensions (e.g., 2D, 4D, etc.)

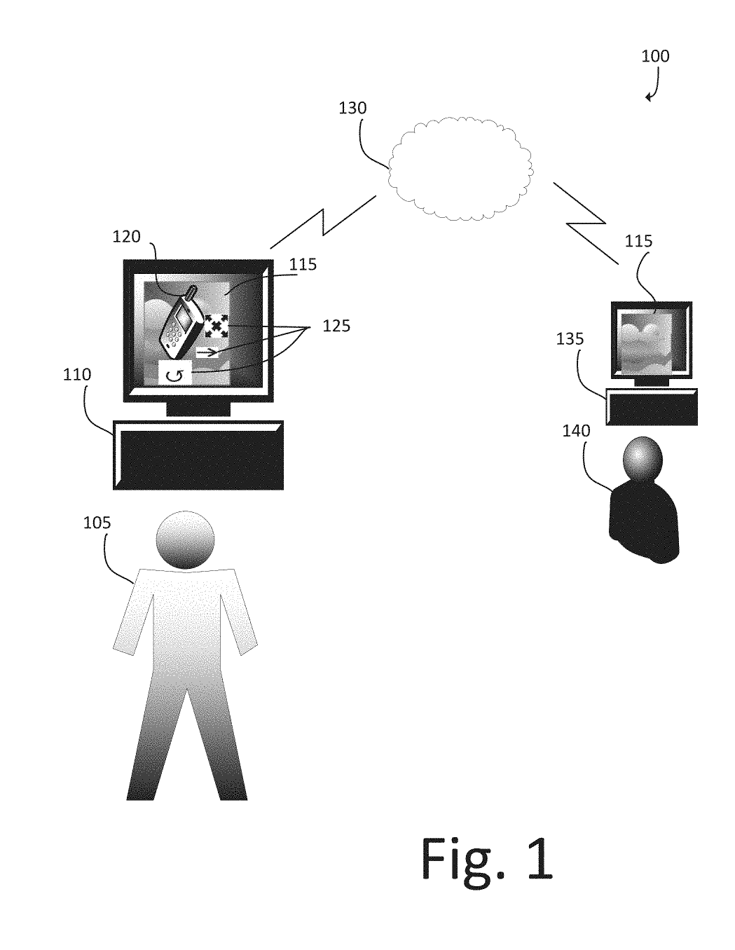

FIG. 1 illustrates a 3D animation system 100 having animation components 125 for moving one or more objects 120 according to one embodiment of the invention. The system 100 includes a user 105, a terminal 110, a 3D model 115, one or more objects 120, one or more animation components 125, a network 130, another terminal 135, and another user 140. The system 100 (e.g., interactive ray tracing system, ray tracing software program, etc.) uses the animation components 125 to move the objects 120 for a given period of time.

The user 105 can create, edit, watch, listen, or interact with the 3D model 115 on the terminal 110. The terminal 110 comprises a computer terminal with a processor and memory. The processor can be used to create and edit the 3D model 115, and the memory can be used to store the 3D model 115. In one embodiment, the 3D model 115 is edited scene by scene. Although the terminal 110 is illustrated as a computer, it could instead be another electronic display device (e.g., a smartphone, a television, a MP3 player, etc.).

The 3D model 115 (e.g., 3D animation, scene, etc.) can be a previously created 3D model made by another user 140 on another terminal 135, or the 3D model 115 can be made from scratch by the user 105 on the terminal 110. The existing 3D model 115 can be imported into the terminal 110 from other computer-aided design (CAD) systems. Some CAD systems include SolidWorks, Autodesk Inventor, and PTC-Creo.

The 3D model 115 can include one or more objects 120. The objects 120 (e.g., 3D object, elements, geometric object, etc.) can be moved over any given start and end time. Alternatively, the movement can be viewed as having a start time and a duration time. Regardless, the position of the objects 120 can be viewed as changing over time, as opposed to changing over frames. The illustrated object 120 is a smartphone. However, the object 120 could be many other things, such as one or more pictures, products, merchandise, persons, or places.

The animation components 125 (e.g., animations) move and change the size, look, color, and/or shape of the object 120. Examples of animation components 125 include rotations, translations, scaling, turntables, camera orbits, camera dolly, camera zooms, material parameter changes, lighting changes, freeform transformations, etc.

Animation components can be created by the user 105 on the terminal 110, or can be imported from a library of existing 3D systems, such as the animations inside FBX formatted files. After the 3D model 115 is imported into the terminal 110, the animations components 125 are applied to the object 120 to affect the movement or look of the object 120. The animation components 125 are applied as offsets to the previous animation component 125 to ensure a consistent and smooth behavior of the animation system 100.

Each animation component 125 acts as an offset to the previous animation component 125, which makes it easy to combine multiple animation components 125 without knowing the precise frame position or orientation that results from the combined animation movement. Without needing to know the specific framing, creating and editing a 3D model 115 is much easier than conventional systems and can be performed by people who are not computer animation experts.

Multiple animation components 125 can be combined. This makes it possible to add multiple rotations, movements, and looks to a given object. For example the user 105 can add a first rotation to a given object for a given time and then later add a second rotation to the object for a separate or overlapping period of time. When the time is overlapping, the effect will be adding the first and second rotations together during the overlapped period of time. If the first and second rotations are the same, then the rotations will double the speed of the rotation of the object 120.

Mathematically, the movements of the animation components 125 can be described using a matrix that describes how to move a specific 3D element in a 3D model (e.g., scene). When multiple animation components 125 are added to the same 3D object, then the combined action of the matrices is computed by multiplying the individual matrices to obtain a combined animation, where each matrix builds upon the previous animation component 125 and uses the previous animation component 125 as the offset. Animation components 125 can be added, deleted, hidden, and modified individually while the system 100 is in use. The animation components 125 can also be copied and pasted, or moved onto other objects.

In one embodiment, the system 100 is a photorealistic real-time ray tracing system. In another embodiment, the system 100 is created using a software program without interactive ray tracing. The system 100 supports interactive playback of animations. Ray tracing is a computer graphics technique for generating an image by tracing the path of light through pixels in an image plane and simulating the effects of its encounters with virtual objects. Ray tracing provides a highly realistic view of the 3D object and allows the 3D model 115 to be visualized interactively. However, ray tracing has a large computational cost, making it better suited for applications where the image can be rendered slowly ahead of time, such as images, film, and television as oppose to real time applications like video games where speed is critical. The ray traced rendering is progressive and the quality improves the longer a given frame is viewed.

If the 3D model 115 has multiple objects 120, then the animation components 125 of the 3D model 115 can be organized hierarchically. In this situation, the animation components 125 can be applied to a group of 3D objects (e.g., parts) within the 3D model 115 (e.g., a scene). Each part may have its own unique set of animation components 125. The animation components 125 are combined hierarchically in order to move all the parts of the 3D model 115 precisely. An example could be a 3D car model, where the wheel parts rotate in a circle inside the model, while the entire car body is being translated (i.e., moved) in a straight line. The wheel will rotate and then move with the entire car body.

The user 105 can also combine animation components 125 into more complex animation components and save them into a library of new animation components. The combination of animation components 125 is represented by one or more offset transforms. An example of a new animation component could be combining a translation movement and a rotation movement into a new animation component. This new animation component can be applied to the object 120 to make the object 120 both translate and rotate over a given period of time.

The network 130 (e.g., the Internet, a distribution platform, etc.) can provide the 3D animation 115 to the terminal 110. Alternatively, the 3D animation 115 can be created on the terminal 110 itself. Also, the network 130 connects the terminal 110 with another terminal 135, such that 3D models 115, objects 120, and animation components 125 can be distributed between the user 105 and another user 140. The network 130 can further comprise a series of servers.

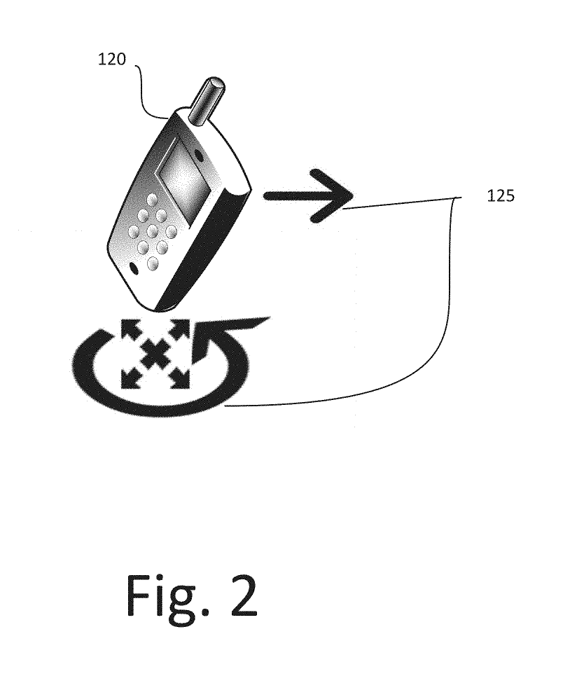

FIG. 2 illustrates the animation components 125 within the system 100 according to one embodiment of the invention. The animation components 125 move the object 120. The animation components 125 illustrated are a lateral side movement, an increase in size movement, and a turntable rotation movement. The animation components 125 have a start time and an end time. Alternatively, the animation components 125 can be viewed as having a start time and a duration time, such that the end time can be calculated simply. In an animation timeline, each animation component 125 can be moved freely to specify when the animation should take place. The animation components 125 can be combined together or occur separately.

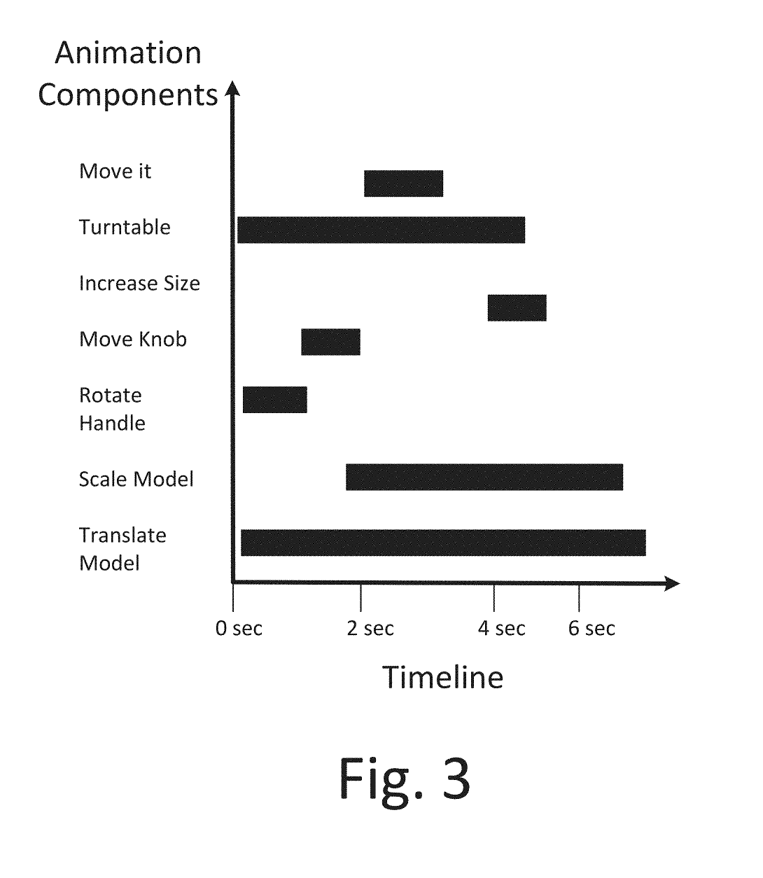

FIG. 3 illustrates an animation timeline according to one embodiment of the invention. The animation timeline (e.g., timeline window) includes animation components that are activated during a specified period of time for a particular object. The timeline in the horizontal-axis controls the timing of the individual animation components. The timeline highlights that the movements of animation components can be created and edited relative to time (e.g., in seconds), as opposed to the conventional method occurring between specific frames.

The animation components illustrated include more than just the three animation components 125 illustrated previously. For a particular object, the illustrated animation components can include move it, turntable, increase size, move knob, rotate handle, scale model, and translate model, etc. The system has a library containing many more possible animation components, although less than all of the library's animation components are typically applied to any given object. Each animation component is illustrated as starting at a particular time, ending at a particular time, and having a given duration time. For example, the “move it” animation component begins at two seconds and ends at three seconds, having a duration time of one second. Although this timeline is illustrated in terms of a whole number of seconds, the time can be more or less precise (e.g., 0.1 second, 0.5 seconds, 1 second, 2 seconds, 10 seconds, etc.). The number of seconds can be set by the user 105.

The timeline illustrates when each animation component is accessed and applied. The start time, end time, and duration can easily and freely be modified based on the preferences of the user 105. In one embodiment, the modification occurs by moving a slider (not shown) within the timeline. For example, the “move it” animation component can be extended from one second in duration to four seconds in duration by the user selecting and dragging the end time from three second to six seconds. Animation components can also be easily added, hidden, or deleted. The animation components can overlap or occur separately. For example, the “move it” and “turntable” animation components are illustrated as overlapping for a one second period of time, whereas the “increase size” and “move knob” animation components are illustrated as occurring separately.

While the animation is playing, it is possible to move the camera, change materials, and add new animations. The individual animation components 125 can also be modified during playback to directly see the effect of the parameter changes. Animations can also be hidden or deleted during playback. It is also possible to freeze (e.g., pause) the animation at a given time and view the object in a specific pose.

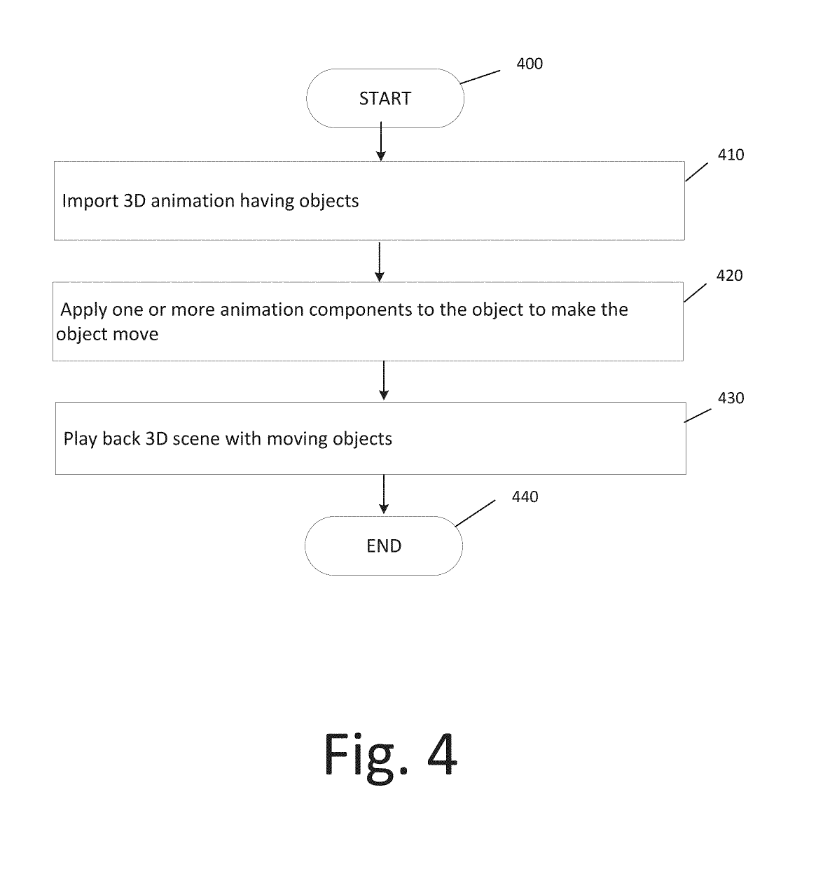

FIG. 4 illustrates a flow chart showing a process of applying animation components 125 to the 3D animation 115 according to one embodiment of the invention. The process starts at step 400. At step 410, the user 105 imports the 3D animation 115 having objects 120. The imported 3D animation 115 may have been created by the user 105 or another user 140. Next, at step 420, the user 105 applies one or more animation components 125 to the objects 120 to make the objects 120 move or change the look of the objects 120. Examples of movements include rotations, translations, scaling, turntables, camera orbits, camera dolly, camera zooms, material parameter changes, lighting changes, and freeform transformations. The user 105 then plays back the 3D model (e.g., scene) with the moving objects 115 at step 430. The 3D animation is augmented with the animation components 125 such that the objects 120 are animated. The process ends at step 440.

As an example to illustrate the calculations performed using the offset animation system according to one embodiment of the invention, an object is moved 1 unit to the left along the x-axis. While the object is being moved, it is also being scaled by 2 (i.e., doubled in size). The user selects the time 0 to 1 second for these actions. Then, at 1 second, the user decides to move the object back to the right by 1 unit along the x-axis for 1 second. The user selects the time 1 to 2 seconds for this action. The calculation of the transformation matrix acting upon the object for these actions is as follows.

From 0 to 1 seconds: TF=[S*t] *[TL*t], where TF is a transformation matrix, S is a scale matrix, t is time, and TL is a translation matrix, for the timeframe 0 to 1 second. The time (t) is a scalar value going from 0 to 1. The scale matrix (S) can be a 4×4 matrix, containing the value 2 along the diagonal and 0 elsewhere to represent the object doubling in size. The translation matrix (TL) can be a 4×4 matrix, containing 1 along the diagonal and 0 elsewhere except for the last row, which contains (1 0 0 1), to represent moving the object 1 unit to the left along the x-axis.

From 1 to 2 seconds: TF=S*TL*[TR*(t−1)], where TL and S are the transformation matrices previously used from 0 to 1 seconds, and TR is a translation matrix, for the timeframe 1 to 2 seconds. The time (t) is a scalar value going from 1 to 2. The translation matrix (TR) can be a 4×4 matrix and represents the moving the object 1 unit to the right along the x-axis. The translation matrix (TR) contains 1 along the diagonal and 0 elsewhere except for the last row, which contains (−1 0 0 1).

Note that the transformation matrix which is acting upon the object still contains the actions from previous transformations (e.g., S*TL). The new translation matrix (TR), from 1 to 2 seconds, simply acts as an offset to the previous transformation (TF) from 0 to 1 seconds.

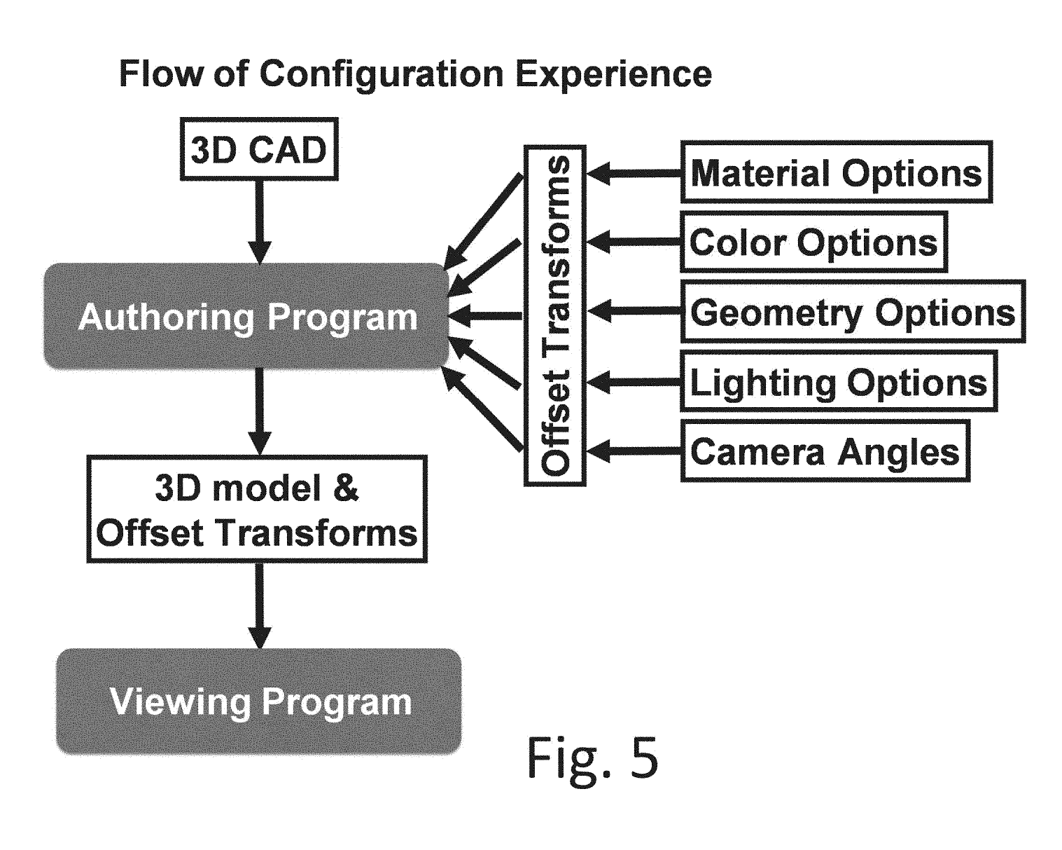

FIG. 5 illustrates a flow chart showing a process of configuring components to a 3D scene according to one embodiment of the invention. The flow chart illustrates a 3D CAD program, an authoring program, a 3D model and offset transforms program, and a viewing program. The 3D CAD program aids in the creation, modification, analysis, or optimization of a 3D design.

The authoring program performs 3D modeling, 3D animation, and 3D rendering to create a 3D model using offset transforms. The authoring program provides a plurality of animation options for specifying, for example, the 3D objects' material, color, geometry, lighting, and camera angles.

The 3D model and offset transforms program provides an offset of the geometry of a prior version of the 3D object. The offset transforms make it possible to save just the basic 3D geometry and represent all of the configuration options using offset transforms, which results in a significantly more compact representation as compared with a full representation of the various configurations.

The viewing program can read a configuration file and show valid configuration components. The viewing program has access to a library of 3D models that can be added to the scene. The viewing program can also save an image of any given configuration or save a description of the 3D model, geometry, materials, colors, lighting, and/or camera angles for a given configuration. The viewing program can show watermark or logo and can annotate the configuration.

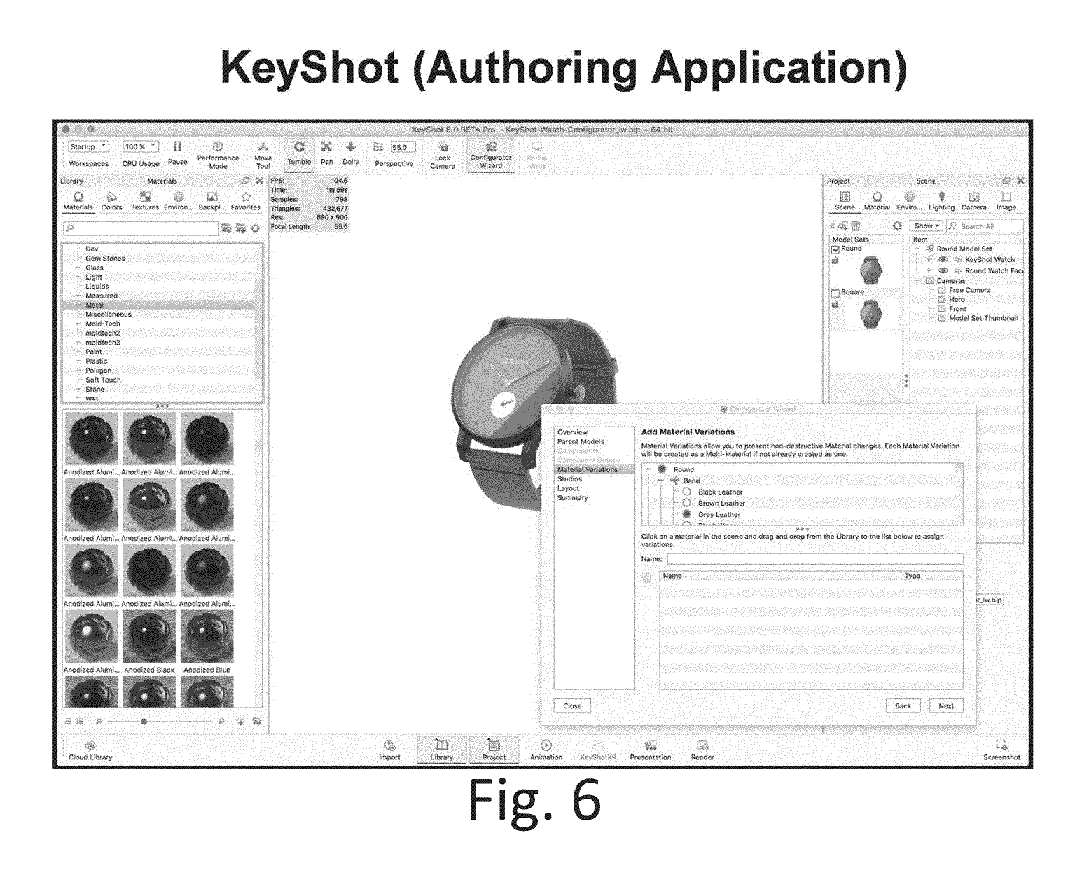

FIG. 6 illustrates an authoring application within the system according to one embodiment of the invention. The authoring program performs 3D modeling, 3D animation, and 3D rendering to create a 3D model using offset transforms. The authoring program also provides a plurality of animation options for specifying, for example, the 3D objects' material, color, geometry, lighting, and camera angles.

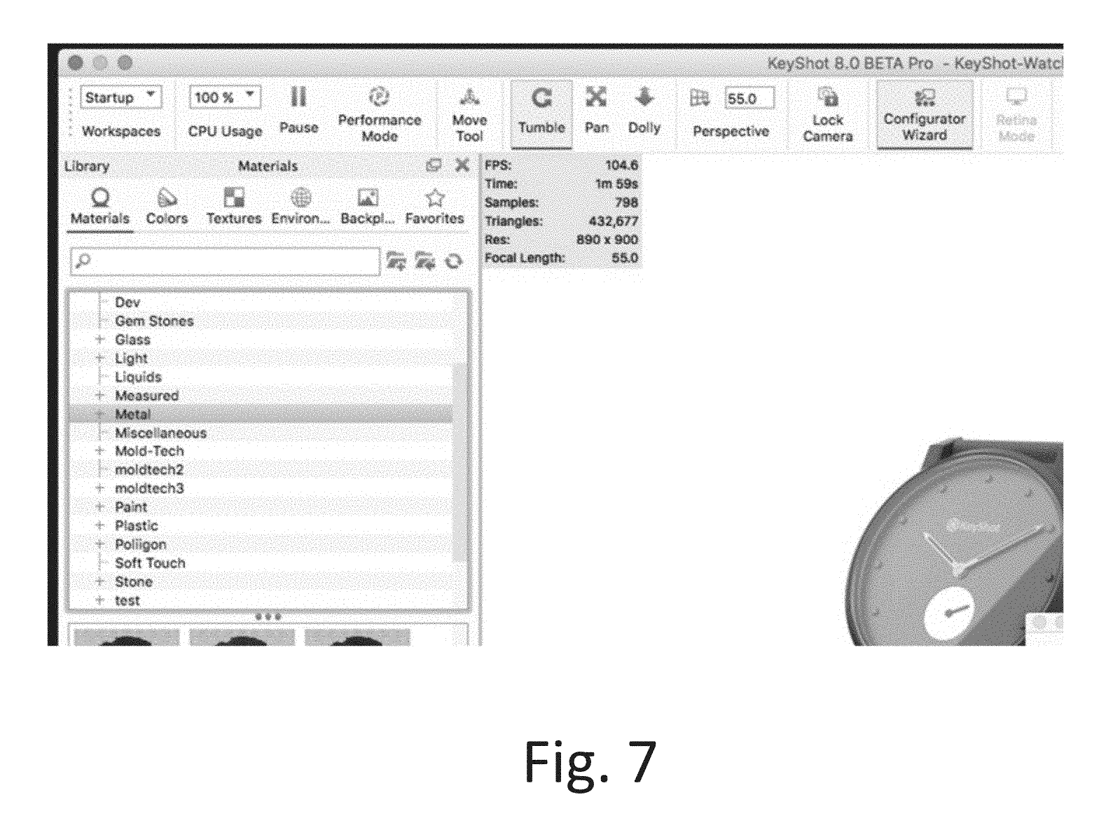

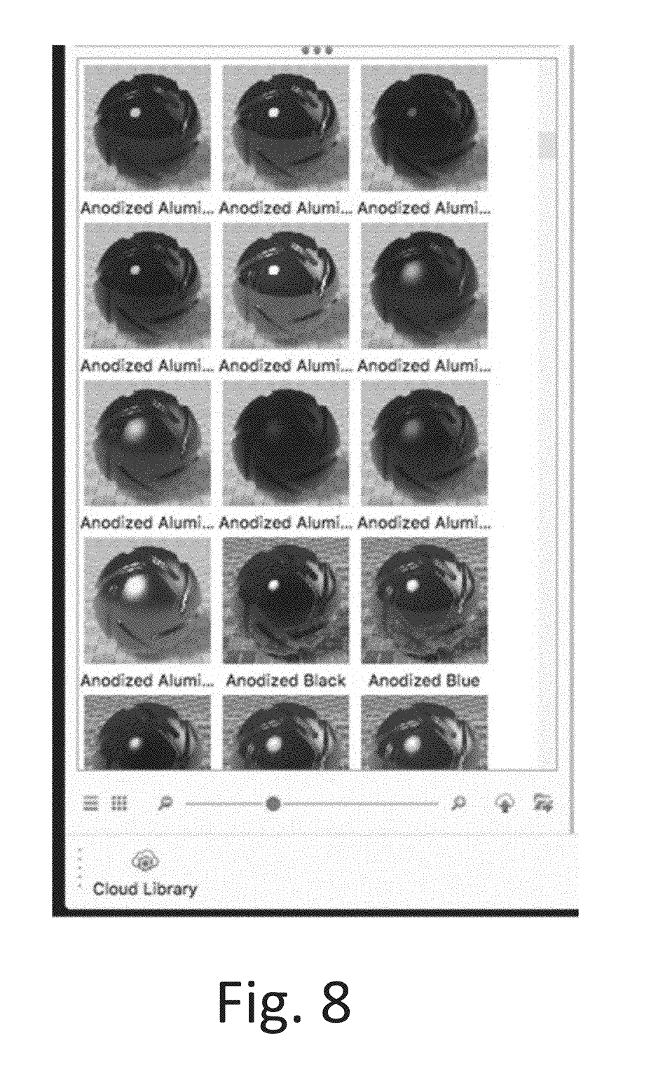

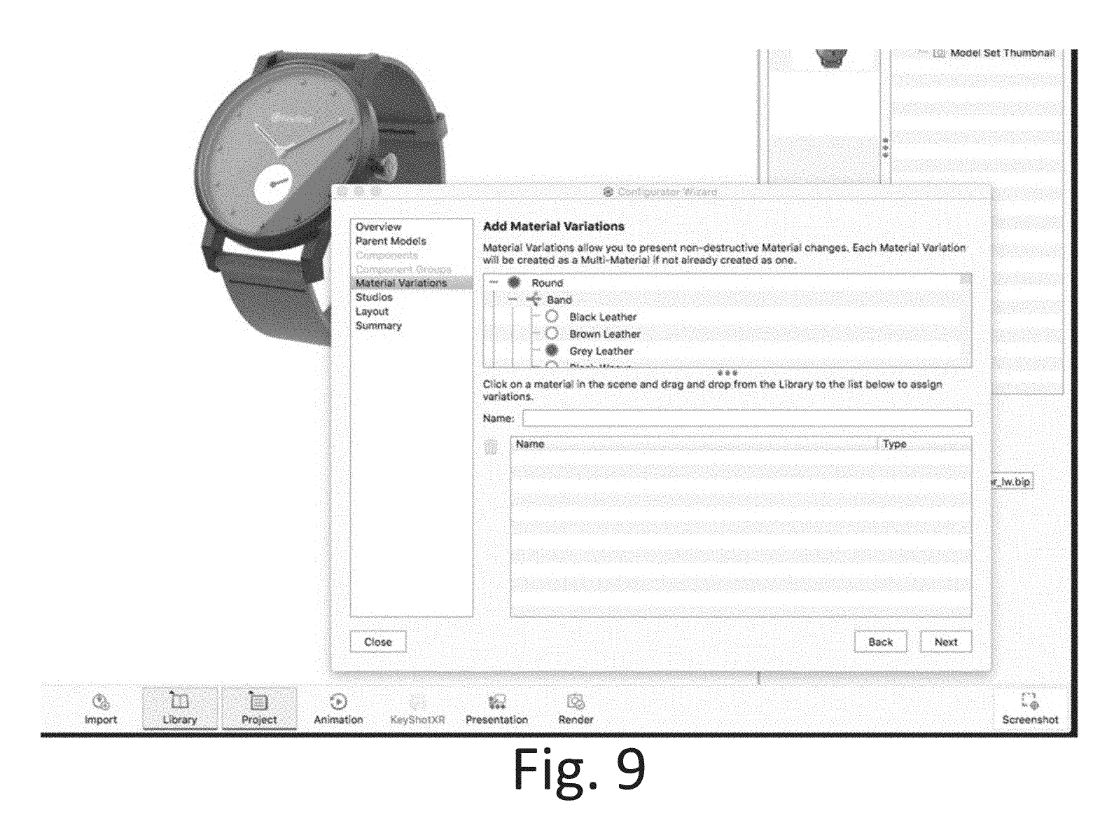

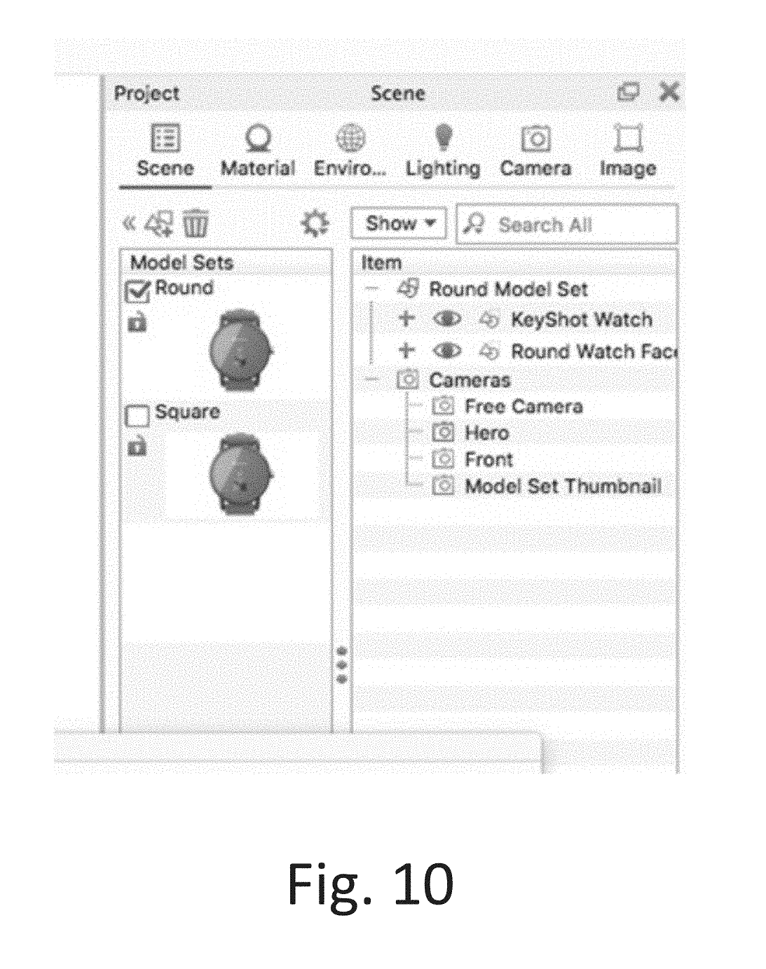

FIGS. 7-10 illustrate close up views of the authoring application according to embodiments of the invention. In FIG. 7, a close up of a library of material change options, which a plurality of material listed for changing a 3D object, and a metal material is selected. In FIG. 8, a plurality of metals are illustrated, including different types of colors of aluminum. In FIG. 9, the configuration wizard illustrates material variations for the band of the 3D object, which is illustrated as a watch. FIG. 10 illustrates an internal component within the 3D object, the internal component being an internal watch with either a round or square shape.

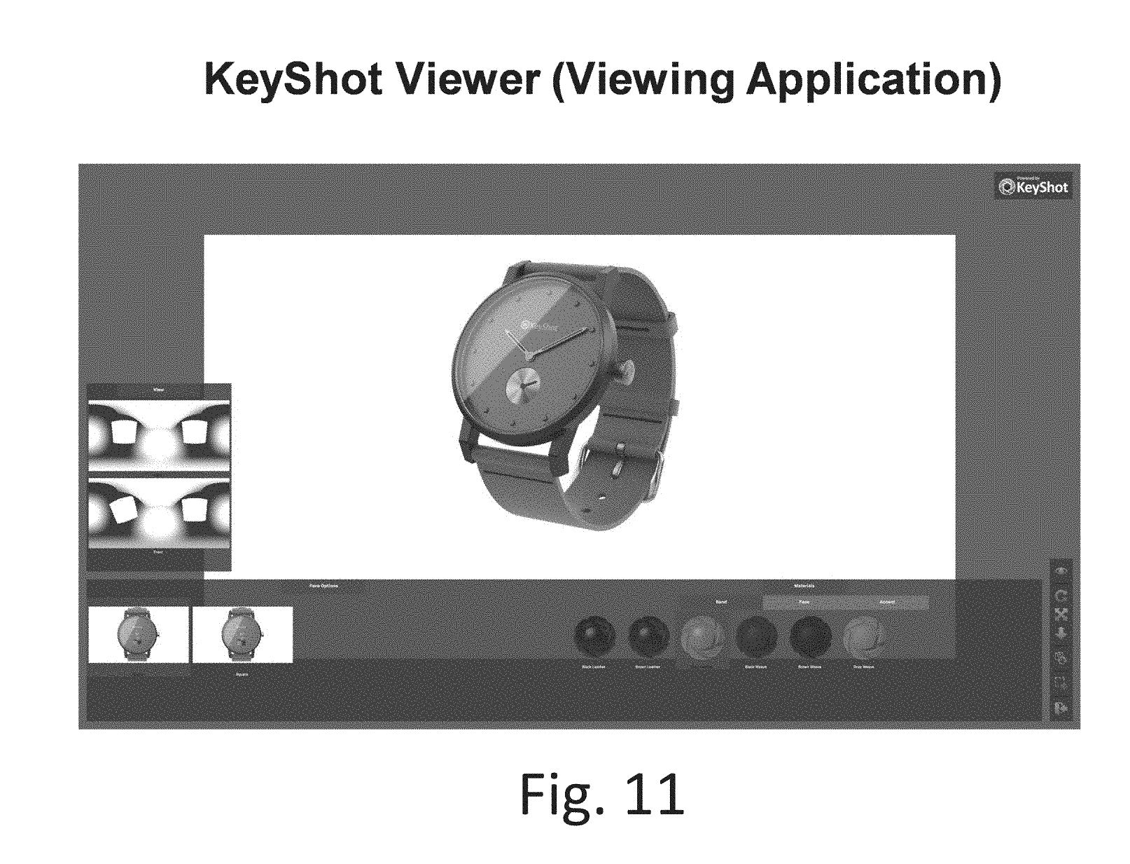

FIG. 11 illustrates a viewing application within the system according to one embodiment of the invention. The viewing program can read a configuration file and show valid configuration components.

The viewer (e.g., keyshot viewer) enables keyshot scenes to be securely shared, interactively viewed, presented, and configured. The configuration includes studio, model, and material configurations in full screen presentation mode. The rendering engine produces photorealistic visual images in real time, meaning the view of the component is moved by the user moving a mouse or touching a touch screen, and the scene will change instantly. A toolbar can have icons of: tumble, pan, or dolly for the user's input; a camera reset icon; and a screenshot save to disk icon to save an image. This save feature outputs a metadata file, e.g., XMP format, which can be opened in any text editor. The metadata file indicates which variations are active and camera information that can be used to make changes the original scene.

Additionally, the viewer can be a stand-alone application that enables secure sharing of keyshot scenes for interactive, photo-realistic 3D model viewing, presentation and configuration, using the same real-time ray tracing render engine as keyshot to produce amazing visuals with speed and quality for design reviews, presentations and collaboration. The viewer includes the following features.

The viewer includes real-time render quality. For example, the viewer can rotate the model or select options to see the scene update instantly, using real-time render capabilities to provide the highest quality experience possible.

The viewer also includes configurator support. For example, the viewer works with custom product configurators and will show unlimited studio, model, and material variations for product reviews or high-res displays.

The viewer includes mouse and touch interaction. The user can explore using a mouse or with your finger on a touch-enabled device. Use traditional mouse and finger gestures or the fly-out toolbar for tumble, pan, and dolly interaction.

The viewer includes a full 360 degree view control. The viewer allows the user to explore your product concepts, configuration and production visuals in full 360 degrees, from far and near, without the need to render a single image.

The viewer includes security control. Control file access and prevent misuse of images and data with password protection and watermark overlay, enabled when saving.

The viewer includes image and metadata output. To output, the user saves a screenshot to his/her computer. The image output includes XMP metadata with active variation and camera information you can reference for edits in keyshot.

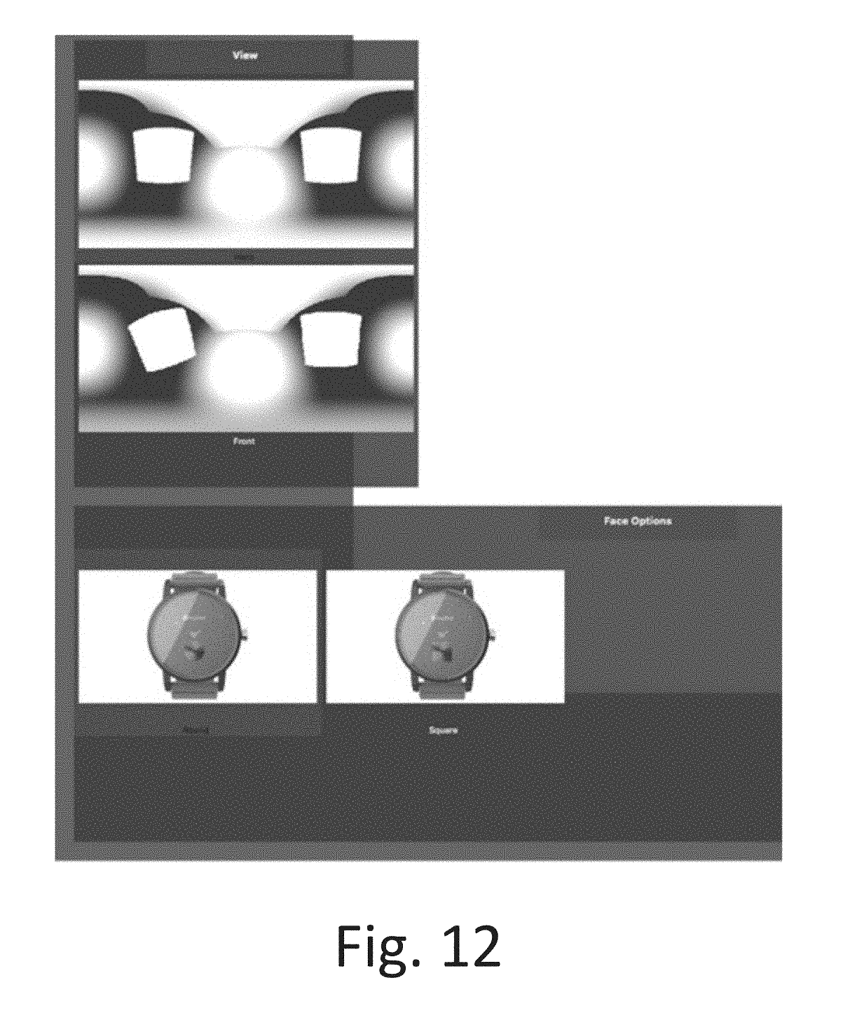

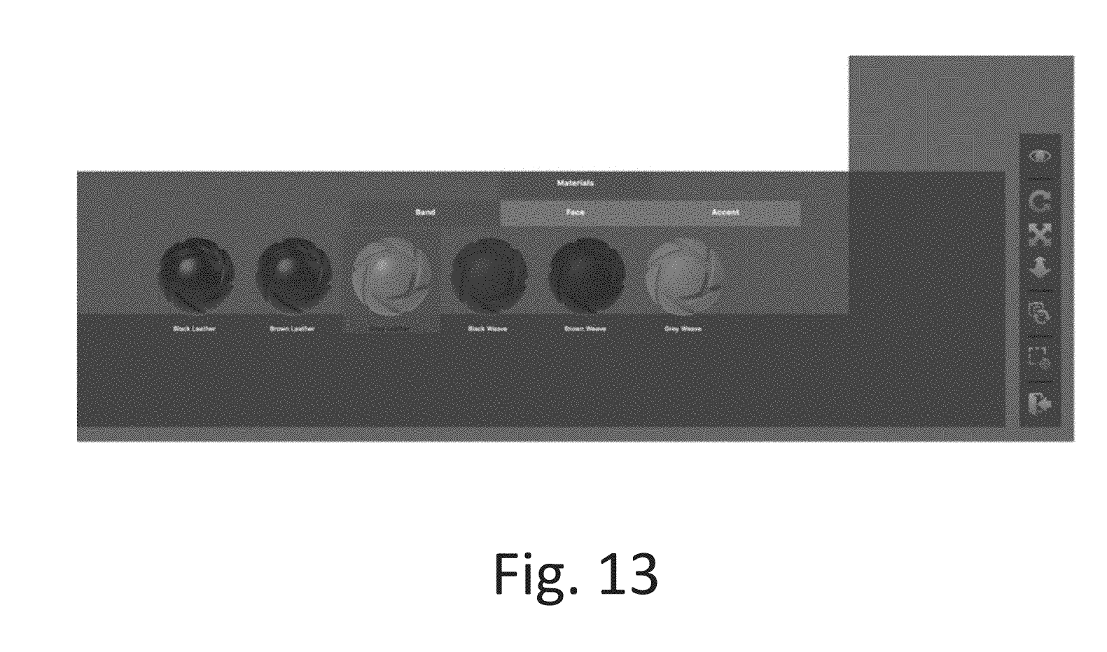

FIGS. 12-13 illustrate close up views of the viewing application according to embodiments of the invention. In FIG. 12, a plurality of views (e.g., front, back) and face options (e.g., round, square) are illustrated. In FIG. 13, a plurality of materials are illustrated for the object's band, face, or accent. Band material options include different colored leathers and weaves.

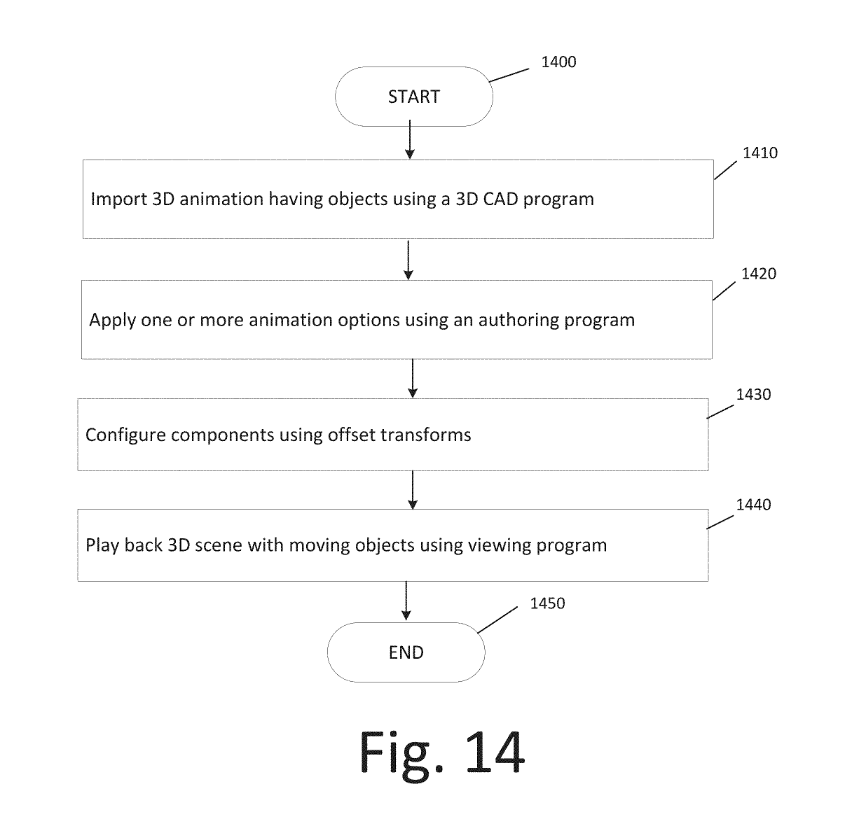

FIG. 14 illustrates a flow chart showing a process of configuring components to a 3D scene according to one embodiment of the invention. The process starts at step 1400. At step 1410, the user imports the 3D animation having objects using a 3D CAD program. The imported 3D animation may have been created by the user or another user. Next, at step 1420, the user applies one or more animation components to the objects using the authoring program. At step 1430, the configuration program configured the components using offset transforms to reduce the component size and make it possible to add multiple rotations or other configurations to a particular object. At step 1440, the user then plays back the 3D model (e.g., scene) with the moving objects at step. The process ends at step 1450.

Further, the disclosure comprises embodiments according to the following clauses:

Clause a1: A system comprising: a terminal; a three-dimensional model configured to be displaced on the terminal; one or more objects in the three-dimensional model; and a configuration component configured to be applied to the three-dimensional model.

Clause a2: The system of clause a1, wherein the terminal comprises a television or computer.

Clause a3: The system of clause a1, wherein the three-dimensional model comprises a scene configured to be displayed on the terminal.

Clause a4: The system of clause a3, wherein the object comprises an element in the scene.

Clause a5: The system of clause a1, wherein the configuration component comprises an offset transform.

Clause a6: The system of clause a1, wherein the configuration component comprises a translation movement, a rotation movement, a scaling movement, a turntable movement, a camera orbit movement, a camera pan movement, a camera dolly movement, a camera zoom movement, a material parameter change, a lighting parameter change, a change to the hidden/shown state of an object, or a time varying movement specified by a matrix at given time instances.

Clause a7: The system of clause a1, wherein the 3D model and configuration components are saved to a file.

Clause a8: The system of clause a1, further comprising interactive ray tracing.

Clause a9: The system of clause a7, wherein a viewer can read the configuration file and show the valid configuration components.

Clause a10: The system of clause a1, further comprising multiple configuration components, wherein the configuration components are organized hierarchically with configuration components higher up in the hierarchy acting upon configuration components lower in the hierarchy.

Clause a11: The system of clause a7, wherein the file is encrypted.

Clause a12: The system of clause a9, wherein the viewing program has access to a library of 3D models that can be added to the scene.

Clause a13: The system of clause a9, wherein the viewing program can save an image of any given configuration.

Clause a14: The system of clause a9, wherein the viewing program can save a description of the 3D model, geometry, materials, colors, lighting, and/or camera angles for a given configuration.

Clause a15: The system of clause a9, wherein the viewing program shows a watermark.

Clause a16: The system of clause a9, wherein the viewing program shows a logo.

Clause a17: The method of clause a9, wherein the viewer can annotate the configuration.

Clause a18: The method of clause a1, wherein the configuration can contain hotspots can that trigger certain actions when the viewer interacts with them.

Clause b1: A system comprising: a terminal; a three-dimensional model configured to be displayed on the terminal; an object in the three-dimensional model; and an animation component configured to be applied to the object to move the object or to change the look of the object, wherein the animation component has a start time and an end time defined in increments of time.

Clause b2: The system of clause b1, wherein the terminal comprises a television or computer.

Clause b3: The system of clause b1, wherein the three-dimensional model comprises a scene configured to be displayed on the terminal.

Clause b4: The system of clause b3, wherein the object comprises an element in the scene.

Clause b5: The system of clause b1, wherein the animation component comprises an offset transform.

Clause b6: The system of clause b1, wherein the animation component comprises a translation movement, a rotation movement, a scaling movement, a turntable movement, a camera orbit movement, a camera pan movement, a camera dolly movement, a camera zoom movement, a material parameter change, a lighting parameter change, or a time varying movement specified by a matrix at given time instances.

Clause b7: The system of clause b1, further comprising a timeline for adjusting the start time and the end time.

Clause b8: The system of clause b1, further comprising interactive ray tracing.

Clause b9: The system of clause b8, wherein the three-dimensional model is created and played back using the interactive ray tracing.

Clause b10. The system of clause b1, wherein the animation component and the object are configured to be evaluated at a given time.

Clause b11: The system of clause b1, further comprising multiple animation components, wherein the animation components are organized hierarchically with animation components higher up in the hierarchy acting upon animation components lower in the hierarchy.

Clause b12: The system of clause b1, wherein the animation component is configured to be hidden or deleted.

Clause b13: The system of clause b1, wherein the animation component is configured to be copied and pasted to other objects.

Clause b14: The system of clause b1, wherein the animation component is configured to be changed by a user during playback of the three-dimensional model or while paused.

Clause b15: The system of clause b1, further comprising a library of animation components that can be added to the object.

Clause b16: A method comprising: displaying a three-dimensional model on a terminal, wherein the three-dimensional model comprises an object; and applying an animation component to the object to move the object or to change the look of the object, wherein the animation component has a start time and an end time defined in increments of time.

Clause b17: The method of clause b16, wherein the three-dimensional model comprises a scene configured to be displayed on a television or computer.

Clause b18: The method of clause b16, wherein the animation component comprises an offset transform.

Clause b19. The method of clause b16, wherein the animation component comprises a translation movement, a rotation movement, a scaling movement, a turntable movement, a camera orbit movement, a camera pan movement, a camera dolly movement, a camera zoom movement, a material parameter change, a lighting parameter change, or a time varying movement specified by a matrix at given time instances.

Clause b20: The method of clause b16, further comprising a timeline for adjusting the start time and the end time.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The steps of a method or algorithm described in connection with the embodiments disclosed herein may be embodied directly in a computer or electronic storage, in hardware, in a software module executed by a processor, or in a combination thereof. A software module may reside in a computer storage such as in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

It should be understood that the invention is not limited to the embodiments set forth herein for purposes of exemplification, but is to be defined only by a fair reading of the appended claims, including the full range of equivalency to which each element thereof is entitled. Although the invention has been described with reference to the above examples, it will be understood that modifications and variations are encompassed within the spirit and scope of the invention. Accordingly, the invention is limited only by the following claims.

What is claimed is:

1. A system comprising:
a 3-dimensional (3D) computer-aided design (CAD) program on a computer terminal importing a 3D model, the 3D model configured to be displayed on the computer terminal, the 3D model having an object and being represented by base 3D data;
an authorizing program on the computer terminal, the authorizing program applying one or more animation options, the one or more animation options being animation components represented by one or more offset transforms to move the 3D model or change shape or appearance of the 3D model;
a 3D model and offset transform program configuring the animation components to produce a 3D animation from a range of 3D animation configuration options by combining the one or more of the offset transforms to the base 3D data of the 3D model; and
a viewing program configured to play the 3D animation.

2. The system of claim 1, further comprising multiple animation components, wherein the animation components are organized hierarchically with animation components higher up in a hierarchy acting upon animation components lower in the hierarchy.

3. The system of claim 1, wherein the animation components comprises a material option, a color option, a geometry option, a lighting option, or a camera angle.

4. The system of claim 1, wherein the animation components have a start time and an end time defined in increments of time.

5. The system of claim 1, wherein the animation components comprise a translation movement, a rotation movement, a scaling movement, a turntable movement, a camera orbit movement, a camera pan movement, a camera dolly movement, a camera zoom movement, a material parameter change, a lighting parameter change, a change to a hidden or shown state of the object, or a time varying movement specified by a matrix at given time instances.

6. The system of claim 1 further comprising a timeline for adjusting a start time and an end time.

7. The system of claim 1, wherein the animation components are configured to be hidden or deleted.

8. The system of claim 1, wherein the animation components are configured to be changed by a user during playback of the 3D model or while paused.

9. The system of claim 1, wherein the 3D model comprises a scene configured to be displayed on the computer terminal.

10. The system of claim 1, wherein the object comprises an element in a scene.

11. The system of claim 1 further comprising a library of animation components that can be added to the object.

12. The system of claim 1, wherein the viewing program can save a description of the 3D model, geometry, materials, colors, lighting, or camera angles for a given configuration.

13. The system of claim 1, wherein the 3D model and configuration components are saved to a file.

14. A method comprising:
importing a 3D model into a 3D CAD program on a computer terminal, the 3D model configured to be displayed on the computer terminal, the 3D model having an object and being represented by base 3D data;
applying one or more animation options using an authorizing program on the computer terminal, the one or more animation options being animation components represented by one or more offset transforms to move the 3D model or change shape or appearance of the 3D model;
configuring the animation components using a 3D model and offset transform program, the 3D model and offset transform program producing a 3D animation from a range of 3D animation configuration options by combining the one or more of the offset transforms to the base 3D data of the 3D model; and
playing the 3D animation using a viewing program.

15. The method of claim 14, further comprising multiple animation components, wherein the animation components are organized hierarchically with animation components higher up in a hierarchy acting upon animation components lower in the hierarchy.

16. The method of claim 14, wherein the animation components comprises a material option, a color option, a geometry option, a lighting option, or a camera angle.

17. The method of claim 14, wherein the animation components have a start time and an end time defined in increments of time.

18. A system comprising:
an authorizing program on a computer terminal receiving an imported 3D model, the 3D model configured to be displayed on the computer terminal, the 3D model having an object and being represented by base 3D data, the authorizing program applying one or more animation options, the one or more animation options being animation components represented by one or more offset transforms to move the 3D model or change shape or appearance of the 3D model; and
a 3D model and offset transform program configuring the animation components to produce a 3D animation from a range of 3D animation configuration options by combining the one or more of the offset transforms to the base 3D data of the 3D model, the 3D model and offset transform program transmits the 3D animation to a viewing program.

19. The system of claim 18 further comprising multiple animation components, wherein the animation components are organized hierarchically with animation components higher up in a hierarchy acting upon animation components lower in the hierarchy.

20. The system of claim 18, wherein the animation components comprises a material option, a color option, a geometry option, a lighting option, or a camera angle.
